(19) United States
(12) Patent Application Publication
(10) Pub. No.: US 2016/0377863 A1
(43) Pub. Date: Dec. 29, 2016

(54) HEAD-MOUNTED DISPLAY

(71) Applicant: Microsoft Technology Licensing, LLC, Redmond, WA (US)

(72) Inventor: Marko Eromäki, Tampere (FI)

(21) Appl. No.: 14/748,518

(22) Filed: Jun. 24, 2015

(51) Int. Cl. G02B 27/01

(52) U.S. Cl. CPC G02B 27/0172; G02B 27/0176; G02B 2027/0154

(57) ABSTRACT

A head-mounted display is disclosed, wherein the image is displayed to the user via a reflective surface. The uniform reflective surface may be bent or split into two reflective surfaces, enabling two viewing modes. In the first viewing mode, the reflective surface reflects one image to both eyes. In the second viewing mode, the reflective surface reflects separate images to the left eye and to the right eye. The second mode enables three-dimensional viewing. The reflective surface may be partially transparent, allowing Virtual Reality or Augmented Reality views to the user.

### BACKGROUND

Virtual Reality (VR) may replicate an environment that simulates physical presence in places in the real world or imagined worlds. The user may experience Virtual Reality for example by wearing a display configured to display the Virtual Reality to the user. The Virtual Reality may be three-dimensional, wherein the user may wear glasses enabling the three-dimensional vision, or two-dimensional, wherein both eyes of the user see the same display. Virtual Reality glasses may be implemented with displays integrated to the frame such as a virtual reality headset. The display, for example a mobile phone, may be inserted into the frame.

Augmented Reality (AR) provides a live direct or indirect view of a physical, real-world environment whose elements are augmented or supplemented. For a three-dimensional Augmented Reality, the user may wear a set of glasses enabling a transparent view of the real world with the augmented elements.

### SUMMARY

This Summary is provided to introduce a selection of concepts in a simplified form that are further described below in the Detailed Description. This Summary is not intended to identify key features or essential features of the claimed subject matter, and it is not intended to be used to limit the scope of the claimed subject matter.

A head-mounted display is disclosed, wherein the image is displayed to the user via a reflective surface. The uniform reflective surface may be bent or split into two reflective surfaces, enabling two viewing modes. In the first viewing mode, the reflective surface reflects one image to both eyes. In the second viewing mode, the reflective surface reflects separate images to the left eye and to the right eye. The second mode enables three-dimensional viewing. The reflective surface may be partially transparent, allowing Virtual Reality or Augmented Reality views for the user.

Many of the attendant features will be more readily appreciated as they become better understood by reference to the following detailed description considered in connection with the accompanying drawings. The embodiments described below are not limited to implementations which solve any or all of the disadvantages of known display systems.

### DESCRIPTION OF THE DRAWINGS

The present description will be better understood from the following detailed description read in light of the accompanying drawings, wherein:

FIG. 1 is one example of a head-mounted wearable device, wherein the device is illustrated from three side projections;

FIG. 2a is a schematic illustration of a first position of the reflective surface;

FIG. 2b is a schematic illustration of a second position of the reflective surface;

FIG. 3a shows one example of the wearable device in a first position illustrated from below;

FIG. 3b shows one example of the wearable device in a second position illustrated from below;

FIG. 4a is a schematic illustration of a bending reflective surface in a first position;

FIG. 4b is a schematic illustration of a bending reflective surface in a second position;

FIG. 5 shows one example of a detachable display device;

FIG. 6a is one example of the detachable display device mounted onto the wearable frame and configured to reflect the image from below;

FIG. 6b is one example of the detachable display device mounted onto the wearable frame and configured to reflect the image from below;

FIG. 6c is a schematical illustration of the configuration with the display device reflecting an image from below;

FIG. 7a is one example of the detachable display device mounted onto the wearable frame and configured to reflect the image from above;

FIG. 7b is one example of the detachable display device mounted onto the wearable frame and configured to reflect the image from above;

FIG. 7c is a schematical illustration of the configuration with the display device reflecting an image from below.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

Augmented Reality, AR, may be used with a display worn by the user, where computer-generated visual elements are added to the view of a real environment. In one example the display is at least partially transparent, allowing the user to see the real environment though the display, wherein only additional visual elements are displayed. In one example the real environment is reproduced on the display when a camera captures an image of the environment and the image is displayed to the user with the computer-generated elements. As the real environment is three-dimensional, the Augmented Reality experience to the user may be provided with a three-dimensional display, wherein separate eyes receive slightly different images, enabling the depth vision. With the partially transparent glasses, the computer-generated visual elements may be added for both eyes individually, allowing the three-dimensional effect of the Augmented Reality view.

Virtual Reality, VR may be used with a display worn by the user, wherein the environment is not embedded in the real environment. Examples of Virtual Reality applications are computer games or simulators. The Virtual Reality experience may be three-dimensional or it may be two-dimensional. Three-dimensional Virtual Reality may create a more immersive experience to the user. Virtual Reality may be displayed using a device that includes partially transparent glasses that allow the user to continue interacting with the real-world environment, for example, to avoid falling over obstacles while enjoying VR content.

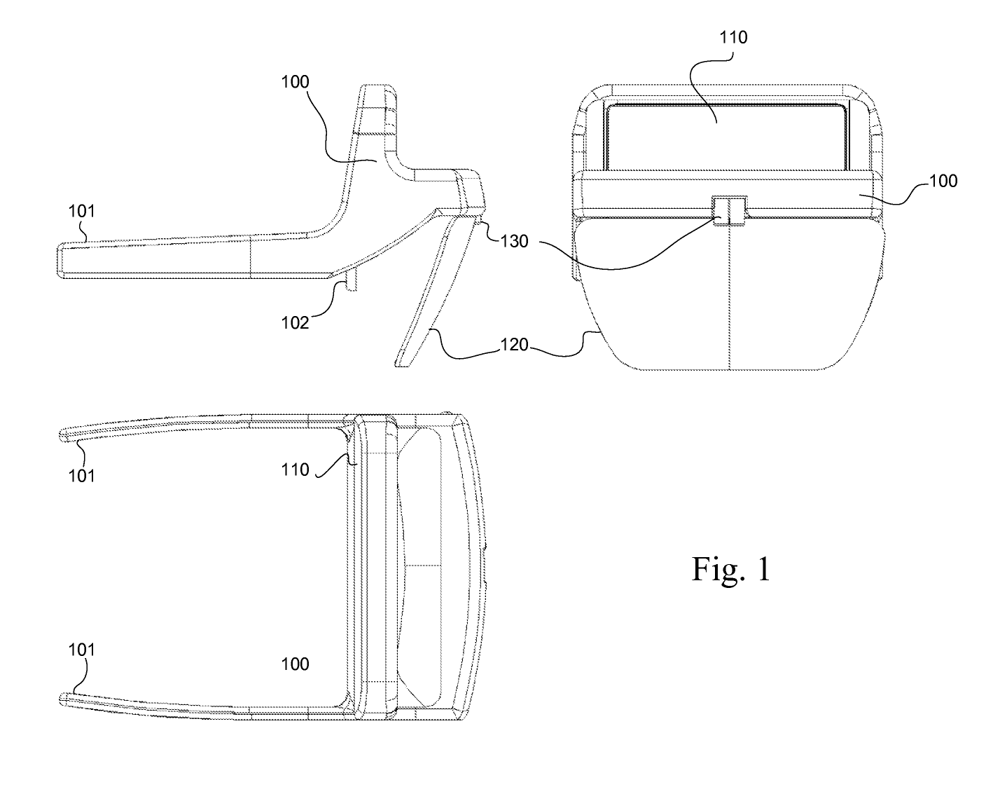

One example of a device suitable for both Augmented Reality views and Virtual Realty views discloses a wearable device that may be head-mounted. The wearable device may be supported on any part of the user, for example the neck, elbow, forehead, nose or any other suitable body part. FIG. 1 shows one example of a head-mounted wearable device, wherein the device is illustrated from three side projections. The head-mounted device includes a frame 100 having bows 101 configured to extend to the temples of the user and further supported by the nose of the user on the nosepad 102. The frames may also comprise more elements that are not illustrated used to improve the fit to the user's head. For example, an elastic band may be attached to the bows 101. The user may secure the frame 100 by tightening the elastic band. A display 110 is arranged in the top portion of the frame 100, close to user's forehead when the user is wearing the device. A reflective surface 120 is arranged to be positioned in front of the user's eyes when the user is wearing the device. The reflective surface is configured at an angle that reflects the image from the display 110 to the eyes of the user, thereby allowing the user to see the display 110 via the reflective surface 120. In one example, the display 110 is integrated into the frame 100; in one example, the display 110 may be inserted to and/or removed from the frame 100. The reflective surface 120 is attached to a hinge 130 that allows the reflective surface 120 to be split from the center into two operating positions.

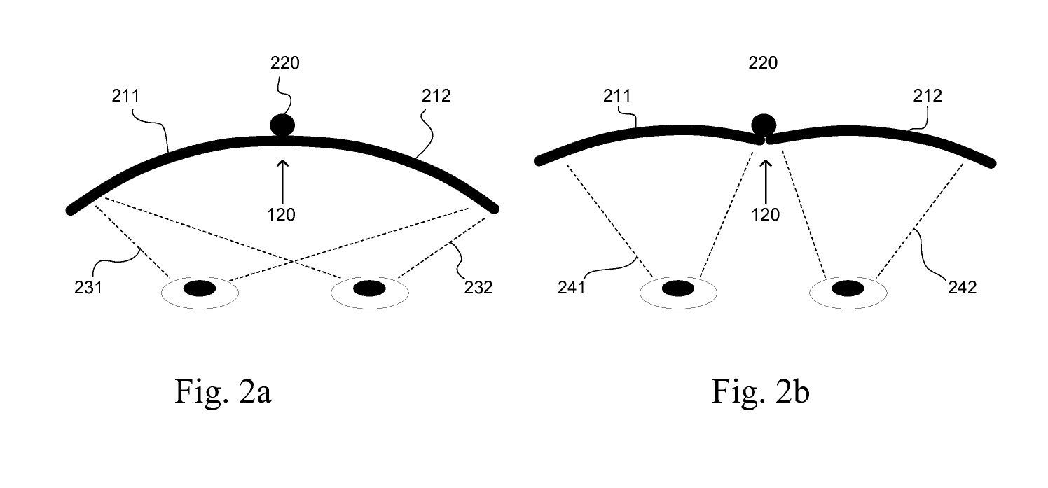

FIG. 2a shows a schematic illustration of a first position of the reflective surface 120. When the device is worn by the user, the eyes of the user see the reflective surface 120. The reflective surface 120 is in this example split into two portions, a first surface portion 211 and a second surface portion 212. The first surface portion 211 and the second surface portion 212 are attached to a hinge mechanism 220 that allows the first surface portion 211 and the second surface portion 212 to move around the axis defined by the hinge mechanism 220. The field of view of the left eye 231 and of the right eye 232 of the user may be uniform along the whole reflective surface 120. The curvature between the first surface portion 211 and the second surface portion 212 is tangentially continuous, causing the view for the user to be a uniform single screen appearance. One application of the first position of the reflective surface 120 is the Augmented Reality view.

FIG. 2b shows a schematic illustration of a second position of the reflective surface 120. The continuous curvature of the first position is turned into two curvatures of the second position. The hinge mechanism 220 defines the extreme position of the second position. The curvature between the reflection elements is angled at the pivot point of the hinge mechanism 220. The field of views between the left eye 241 and the right eye 242 of the user are separated. The hinge mechanism may rotate portions of the reflective surface around an axis of freedom that is parallel or almost parallel to the axis passing the points of the center of the display and the center of the user's eyes. As a consequence, such axis of freedom allows the reflection angle from the display to the eye of the user to remain functional, and the user may see the display in both positions. One application of the second position of the reflective surface 120 is the Virtual Reality view. Displaying separate images to the left eye and to the right eye of the user enables a three-dimensional display. For the Virtual Reality view, the three-dimensional effect may be more immersive to the user than the two-dimensional view. In one example, the hinge mechanism 220 comprises one hinge. In one example, the hinge mechanism 220 comprises at least two hinges, allowing more than one axis of freedom between the first position and the second position.

In one example, the reflective surface 120 is partially transparent, allowing light to penetrate the reflective surface 120. The user may see through the reflective surface 120, and the display 110 may reflect only bright images. The Augmented Reality may be more effective when the images from the display 110 are displayed on transparent glasses. In one example, the reflective surface 120 is opaque, and the Augmented Reality view may be obtained by capturing an image of the real environment by a camera and embedding the augmented elements in the captured image. In this manner, the user perceives a real-world view augmented with virtual content even though the user is viewing an image of the real-world as captured by the camera.

In one example, the reflective surface 120 is a variable reflectivity surface. The reflectivity or the transparency of the reflective surface 120 is configurable. In one example, the reflective surface 102 is electrochromic, wherein the reflective properties of the surface are configurable by applying an electric voltage to the reflective surface 120.

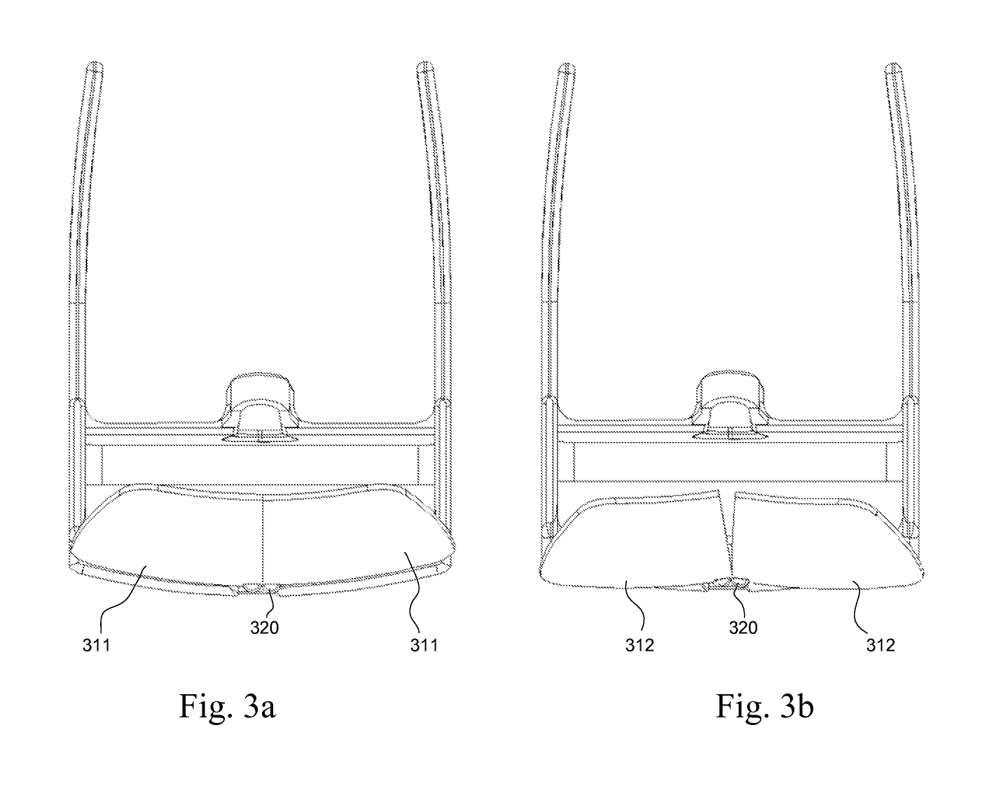

FIG. 3a shows one example of the wearable device illustrated from below, having the reflective surface 311 in the first position. The display is not illustrated. Two halves of the reflective surface 311 are tangentially connected, wherein the user may see the reflected image without an edge in the middle and with a wide field of vision. FIG. 3b shows the same example of the wearable device in the second position, wherein the two halves 312 are separated and the display may reflect a three-dimensional image to the user. In this example the hinge mechanism 320 comprises two hinges.

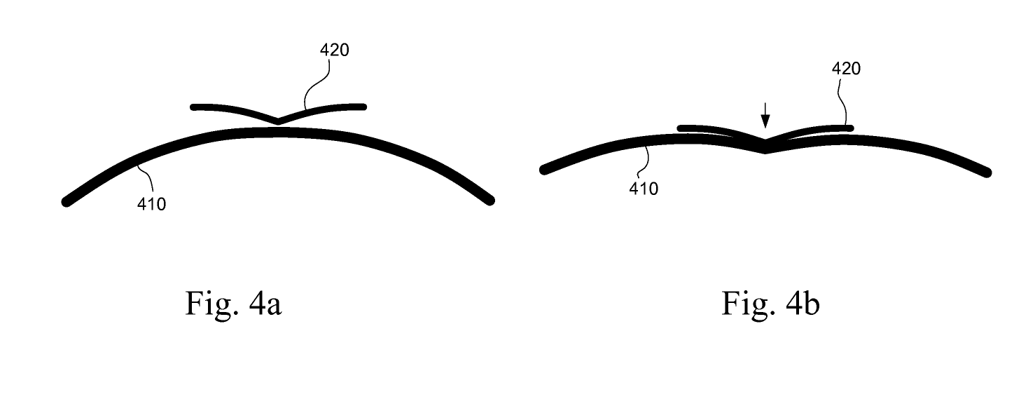

In one example, the reflective surface is configured to bend into different positions. FIG. 4a shows one example, wherein the reflective surface 410 is in the first position. A supporting element 420 is configured to apply pressure onto the reflective surface from the middle, causing the continuous reflective surface to bend from the first position of FIG. 4a to the second position shown in FIG. 4b. In this example, the supporting element moves by turning a lever; in one example, the supporting element is moved by an actuator. The reflective surface 410 conforms to the shape of the supporting element 420 when the pressure is applied to the reflective surface 410.

One example discloses a system that may be used as a wearable device. The elements of the system may be connected or integrated, together forming a complete functioning device. For example, the display device may be integrated into the frame, at a position where the image may be reflected to the eye of the user. In one example, the display device may be separated from the system. In one example, the display device is a smartphone, a tablet or a similar multipurpose device having a display that is suitable for reflecting an image to the eye of the user when the wearable device is worn. The frame may comprise multiple elements, for example the nosepad or the bow may be detachable or interchangeable.

The display device, the system or the wearable device may comprise at least one sensor configured to detect the user's movements when the wearable device is worn. The Augmented Reality or Virtual Reality modes may utilize the sensor information to modify the visual information displayed to the user according to the user's movements. In one example the sensor is a gyroscope sensor. In another example, a sensor system such as an inertial measurement unit comprising an accelerometer, gyroscope, and a compass is employed. Further, a GPS receiver could be employed.

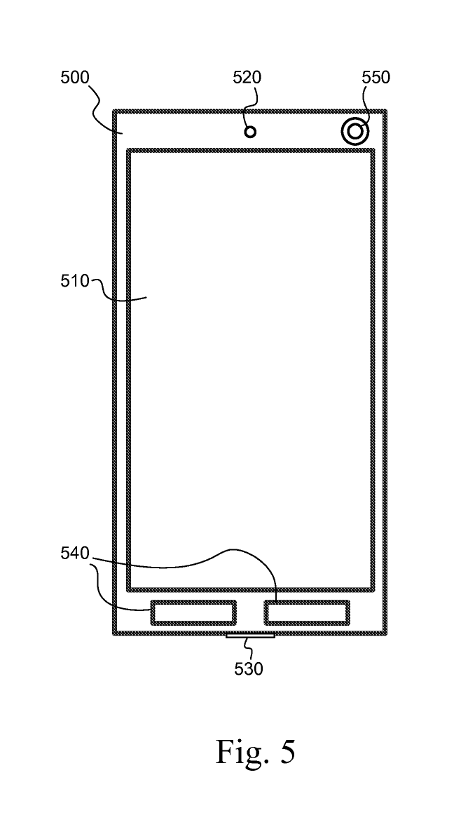

FIG. 5 shows one example of a detachable display device configured to project an image to the user when the wearable device is worn. The display device comprises a body 500, a display 510; and in some examples a speaker 520, a microphone 530 and keys 540. The display device may comprise an imaging apparatus 550, a camera. The display device may be a smartphone, a tablet or a device with a suitable display size to be reflected to the user's eyes. The display size may be compensated for with the curvature of the reflective surface. The curved reflective surface may enlarge the display size, thus enabling the display device to present stereoscopic images or three-dimensional images. Three-dimensional images are produced by displaying images having objects with an offset corresponding the distance between the human eyes, thereby creating an illusion of depth vision. In one example the display device comprises at least one gyroscope sensor for sensing the user's movements, for example head tracking.

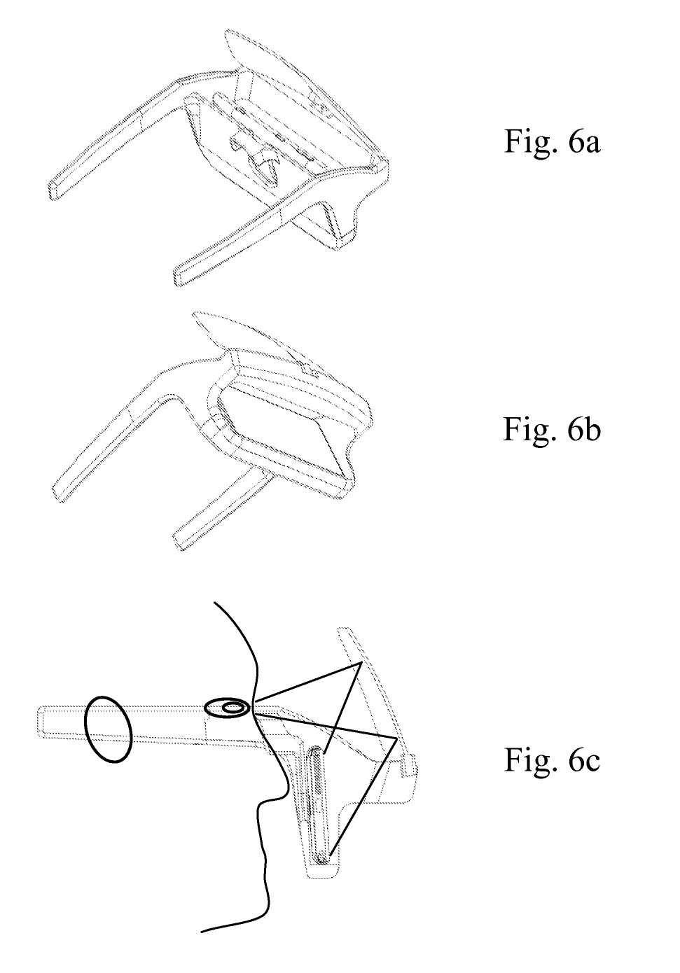

FIG. 6a and FIG. 6b illustrate one example of the detachable display device 610 mounted onto the wearable frame 620. In this example, the detachable display device 610 is positioned in front of the nosepad 630, and the image is reflected to the eyes of the user from below. FIG. 6c is a schematical illustration of the configuration with the display device reflecting an image from below when the device is worn by the user.

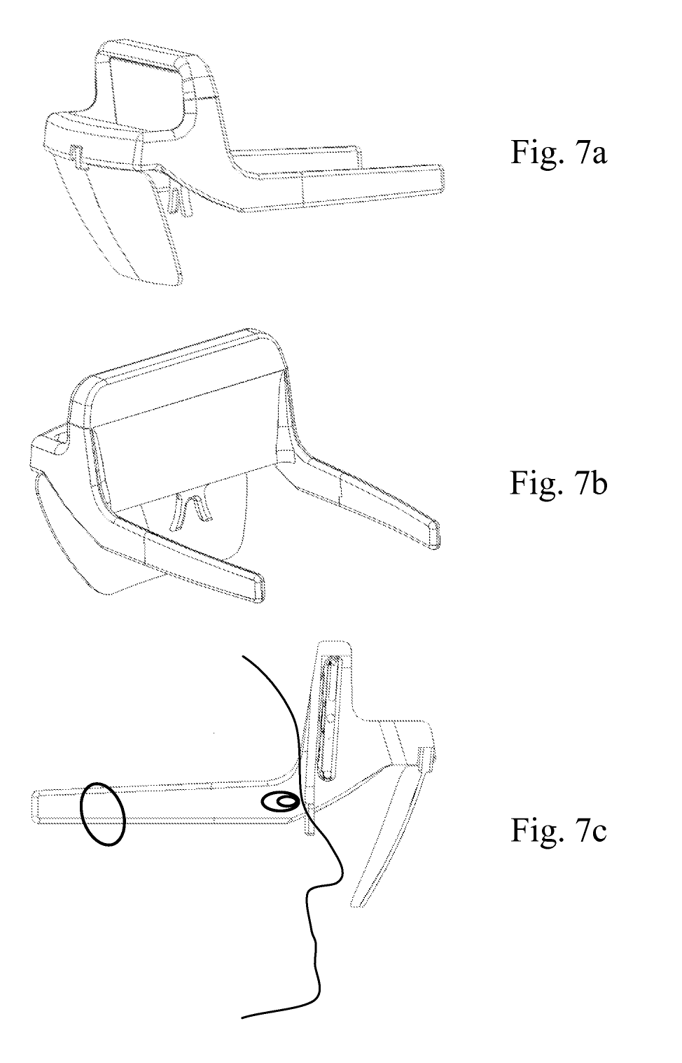

FIG. 7a and FIG. 7b illustrate one example of the detachable display device 710 mounted onto the wearable frame 720. In this example, the detachable display device 710 is positioned in front of the user's forehead, and the image is reflected to the eyes of the user from above. FIG. 7c is a schematical illustration of the display device reflecting an image from below when the device is worn by the user.

The distance between the reflective surface and the eye of the user may differ between different users. Users have anatomical differences, for example, in head size and shape, pupillary distances, and eyesight capability. Therefore the wearable device, the system or the head-mounted device comprise in one example adjusting elements to match the individual anatomy. For example the distance between the eye and the reflective surface may be adjustable. The curvature of the reflective surface may be adjustable according to the vision of the user.

Although the present examples are described and illustrated herein as being implemented with the display device being a smartphone, the display device described is provided as an example and not a limitation. As those skilled in the art will appreciate, the present examples are suitable for application in a variety of wearable devices. The applications may be for example gaming consoles, mobile gaming systems or mobile Augmented Reality systems.

One aspect discloses a device comprising: a reflective surface; a display configured to project an image from the reflective surface to an eye of the user; the reflective surface having a first position configured to reflect an image both to the left eye and to the right eye of the user; and a second position configured to reflect a first image to the left eye of the user and a second image to the right eye of the user.

In an example, the reflective surface is partially transparent. In an example, the reflective surface comprises a first surface portion, a second surface portion and at least one hinge mechanism, wherein the at least one hinge mechanism attaches the first surface portion to the second surface portion and the at least one hinge mechanism is configured to allow the movement between the first position and the second position. In an example, the reflective surface comprises a single surface that is configured to bend into the first position and into the second position; and the device comprises a movable supporting element configured to cause the reflective surface to bend into the first position and into the second position. In an example, the reflective surface comprises a continuous surface that is configured to bend into the first position and into the second position. In an example, the reflective surface comprises a variable reflectivity surface.

One aspect discloses a system comprising a reflective surface; a display configured to project an image from the reflective surface to an eye of the user; the reflective surface having a first position configured to reflect an image both to the left eye and to the right eye of the user; and a second position configured to reflect a first image to the left eye of the user and a second image to the right eye of the user. In an example, the reflective surface is partially transparent. In an example, the reflective surface comprises a first surface portion, a second surface portion and at least one hinge mechanism, wherein the at least one hinge mechanism attaches the first surface portion to the second surface portion and the at least one hinge mechanism is configured to allow the movement between the first position and the second position. In an example, the reflective surface comprises a single surface that is configured to bend into the first position and into the second position. In an example, the system comprises a movable supporting element configured to cause the reflective surface to bend into the first position and into the second position. In an example, the reflective surface comprises a continuous surface that is configured to bend into the first position and into the second position. In an example, the reflective surface comprises a variable reflectivity surface.

One aspect discloses a device comprising a reflective surface; a frame configured to receive a display; wherein, as received by the frame, the display device is configured to reflect an image from the reflective surface to an eye of a user; the reflective surface having a first position configured to reflect an image both to the left eye and to the right eye of the user; and a second position configured to reflect a first image to the left eye of the user and a second image to the right eye of the user. The display device may be a detachable element. In an example, the reflective surface is partially transparent. In an example, the reflective surface comprises a first surface portion, a second surface portion and at least one hinge mechanism, wherein the at least one hinge mechanism attaches the first surface portion to the second surface portion and the at least one hinge mechanism is configured to allow the movement between the first position and the second position. In an example, the reflective surface comprises a single surface that is configured to bend into the first position and into the second position. In an example, a movable supporting element is configured to cause the reflective surface to bend into the first position and into the second position. In an example, the reflective surface comprises a continuous surface that is configured to bend into the first position and into the second position. In an example, the reflective surface comprises a variable reflectivity surface.

Alternatively, or in addition, the functionality described herein can be performed, at least in part, by one or more hardware components or hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs). For example, some or all of the display device functionality, for example providing the Augmented Reality view or the Virtual Reality view, may be performed by one or more hardware logic components.

An example of a device, a wearable device, a system or a head-mounted device described hereinbefore comprises a computing-based device comprising one or more processors which may be microprocessors, controllers or any other suitable type of processors for processing computer executable instructions to control the operation of the device in order to control one or more sensors, receive sensor data and use the sensor data. Platform software comprising an operating system or any other suitable platform software may be provided at the computing-based device to enable application software to be executed on the device.

The computer executable instructions may be provided using any computer-readable media that are accessible by a computing based device. Computer-readable media may include, for example, computer storage media such as memory and communications media. Computer storage media, such as memory, include volatile and non-volatile, removable and non-removable media implemented in any method or technology for storage of information such as computer readable instructions, data structures, program modules or other data. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media do not include communication media. Therefore, a computer storage medium should not be interpreted to be a propagating signal per se. Propagated signals may be present in computer storage media, but propagated signals per se are not examples of computer storage media. The computer storage media may be distributed or located remotely and accessed via a network or other communication link, for example by using communication interface.

The computing-based device may comprise an input/output controller arranged to output display information to a display device which may be separate from or integral to the computing-based device, the system, the wearable device or the head-mounted device. The display information may provide a graphical user interface, for example, to display hand gestures tracked by the device using the sensor input or for other display purposes or the display may provide additional elements to the view of the user when the wearable device is worn by the user. The input/output controller is also arranged to receive and process input from one or more devices, such as a user input device (e.g. a mouse, keyboard, camera, microphone or other sensor). In some examples the user input device may detect voice input, user gestures or other user actions and may provide a natural user interface (NUI). This user input may be used to configure the device for a particular user such as by receiving information about bone lengths of the user. In an embodiment the display device may also act as the user input device if it is a touch sensitive display device. The input/output controller may also output data to devices other than the display device, e.g. a locally connected printing device. In an example the computing-based device, the system, the wearable device, the head-mounted device or a component in the system comprises wireless interface for communication between external devices. Examples of wireless interface are Bluetooth or Wi-Fi. Wi-Fi is a local area wireless computer networking technology that allows electronic devices to network, Bluetooth is a wireless technology standard for exchanging data over short distances between electronic devices.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not only include propagated signals. Propagated signals may be present in tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Any range or device value given herein may be extended or altered without losing the effect sought.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A device comprising:
a reflective surface;
a display configured to project an image from the reflective surface to an eye of the user;
the reflective surface having a first position configured to reflect an image both to the left eye and to the right eye of the user; and
a second position configured to reflect a first image to the left eye of the user and a second image to the right eye of the user.

2. A device according to claim 1, wherein the reflective surface is partially transparent.

3. A device according to claim 1, wherein the reflective surface comprises a first surface portion, a second surface portion and at least one hinge mechanism, wherein the at least one hinge mechanism attaches the first surface portion to the second surface portion and the at least one hinge mechanism is configured to allow the movement between the first position and the second position.

4. A device according to claim 1, wherein the reflective surface comprises a single surface that is configured to bend into the first position and into the second position; and
the device comprises a movable supporting element configured to cause the reflective surface to bend into the first position and into the second position.

5. A device according to claim 1, wherein the reflective surface comprises a continuous surface that is configured to bend into the first position and into the second position.

6. A device according to claim 1, wherein the reflective surface comprises a variable reflectivity surface.

7. A system comprising:
a reflective surface;
a display configured to project an image from the reflective surface to an eye of the user;
the reflective surface having a first position configured to reflect an image both to the left eye and to the right eye of the user; and
a second position configured to reflect a first image to the left eye of the user and a second image to the right eye of the user.

8. A system according to claim 7, wherein the reflective surface is partially transparent.

9. A system according to claim 7, wherein the reflective surface comprises a first surface portion, a second surface portion and at least one hinge mechanism, wherein the at least one hinge mechanism attaches the first surface portion to the second surface portion and the at least one hinge mechanism is configured to allow the movement between the first position and the second position.

10. A system according to claim 7, wherein the reflective surface comprises a single surface that is configured to bend into the first position and into the second position.

11. A system according to claim 10, comprising a movable supporting element configured to cause the reflective surface to bend into the first position and into the second position.

12. A system device according to claim 7, wherein the reflective surface comprises a continuous surface that is configured to bend into the first position and into the second position.

13. A system according to claim 7, wherein the reflective surface comprises a variable reflectivity surface.

14. A device comprising:
a reflective surface;
a frame configured to receive a display;
wherein, as received by the frame, the display device is configured to reflect an image from the reflective surface to an eye of a user;
the reflective surface having a first position configured to reflect an image both to the left eye and to the right eye of the user; and
a second position configured to reflect a first image to the left eye of the user and a second image to the right eye of the user.

15. A device according to claim 15, wherein the reflective surface is partially transparent.

16. A device according to claim 15, wherein the reflective surface comprises a first surface portion, a second surface portion and at least one hinge mechanism, wherein the at least one hinge mechanism attaches the first surface portion to the second surface portion and the at least one hinge mechanism is configured to allow the movement between the first position and the second position.

17. A device according to claim 15, wherein the reflective surface comprises a single surface that is configured to bend into the first position and into the second position.

18. A device according to claim 17, wherein a movable supporting element is configured to cause the reflective surface to bend into the first position and into the second position.

19. A device according to claim 15, wherein the reflective surface comprises a continuous surface that is configured to bend into the first position and into the second position.

20. A device according to claim 15, wherein the reflective surface comprises a variable reflectivity surface.
